(19) United States
(12) Patent Application Publication
(10) Pub. No.: US 2026/0054269 A1
(43) Pub. Date: Feb. 26, 2026

(54) GRINDER MACHINE WITH IMPROVED SCREEN DIVERTER SYSTEM

(71) Applicant: Franklin Miller, Inc., Livingston, NJ (US)

(72) Inventors: William Galanty, Livingston, NJ (US); Alexsander Gotliboym, Scotch Plains, NJ (US)

(73) Assignee: Franklin Miller, Inc., Livingston, NJ (US)

(21) Appl. No.: 19/217,724

(22) Filed: May 23, 2025

Related U.S. Application Data
(60) Provisional application No. 63/651,780, filed on May 24, 2024.

(51) Int. Cl. B02C 18/22; B01D 29/00; B01D 33/27; B01D 33/46; B02C 18/14; B02C 23/08

(52) U.S. Cl. CPC B02C 18/2266; B01D 29/0097; B01D 33/27; B01D 33/466; B02C 18/142; B02C 23/08

(57) ABSTRACT

The present invention relates to comminutors for breaking down waste and, more particularly, comminutors having a screen that rotates for directing large waste particles into a cutting assembly. In addition to a rotating screen, a second, stationary screen is provided that has horizontal ribs adapted to cooperate with interleaved ribs on the rotating screen so as create a composite fine screen at an inlet end of the comminutor, while creating a coarse screen at the outlet end of the comminutor.

### CROSS-REFERENCE TO RELATED APPLICATION

This application claims priority to U.S. Provisional Patent Application Ser. No. 63/651,780 filed May 24, 2024, the entire disclosure of which is incorporated herein by reference.

### STATEMENT REGARDING FEDERALLY SPONSORED RESEARCH

None.

### FIELD OF THE INVENTION

The present invention relates to grinding (comminuting) machines, and more particularly, to grinding and screening machines for installation in wastewater channels and methods for using same.

### BACKGROUND OF THE INVENTION

Wastewater channels employ grinding (comminuting) systems to perform particle reduction of materials commonly found in wastewater streams such as rags, plastics, wood, tampons, sanitary napkins, wipes and more. Many such systems include a rotating drum (or drums) having screens. A common problem in these prior art grinding systems is the accumulation of solids trapped within the rotating drum screen(s) over time. This results in a significant degrading of the liquid capacity of the wastewater channel unit and premature failure of the grinding system.

### SUMMARY

The invention provides a more effective grinding (comminuting) machine for installation in wastewater channels. This grinding and screening machine employs a rotatable screen (i.e., a rotating drum screen) feeding solids into a cutter assembly for more effective particle reduction of solids commonly found in wastewater streams such as rags, plastics, wood, tampons, sanitary napkins, wipes and more. An enhanced flow capacity is achieved by combining the rotatable screen with the grinder.

It is the further objective of this invention to improve the design of rotary drum screens, while reducing the maintenance issues associated therewith.

In an exemplary embodiment, the present invention is a grinder machine that employs, in combination, a rotary/rotating drum screen and a stationary screen. The rotatable drum screen interleaves with the stationary screen to create effectively a composite fine screen at the inlet side/face of the machine's housing and a coarser screen at the outlet side/face of the machine's housing, thereby minimizing, if not eliminating, the accumulation of solids trapped within the rotatable screen over time. The screens are located close to an associated cutter assembly to enhance transfer of solids to the cutters without the solids bypassing the cutters.

In a first embodiment, the present invention relates to a comminuting apparatus adapted for screening a wastewater stream flowing through a channel and for grinding solids in the wastewater stream. The comminuting apparatus includes a housing positionable in the channel, with an inlet end for receiving wastewater flowing through the channel and an outlet end for discharging wastewater from the housing. A rotatable cutter assembly is mounted to the housing between the inlet and outlet ends, and adjacent one side of the housing. The cutter assembly can be configured to grind solids in the wastewater stream upon rotation of the cutter assembly. Additionally, a rotatable screen is mounted to the housing between the inlet and outlet ends and adjacent an opposite side of the housing with a portion of the rotatable screen being in close proximity to the cutter assembly. Furthermore, the rotatable screen can have a plurality of spaced-apart, generally horizontal ribs configured to transfer solids captured thereon to the cutter assembly in response to rotation of the rotatable screen. In this manner, the spaced-apart ribs cooperate with each other to define a plurality of generally horizontal slots sized and shaped so as to permit wastewater to flow through the rotatable screen. In addition to the rotatable screen, a stationary screen is mounted to the housing in a fixed orientation relative to the cutter assembly and to the rotatable screen. The stationary screen has a second plurality of space-apart, generally horizontal ribs, a first screen section attached to the housing at the opposite side thereof and extending toward the one side thereof in close proximity to the rotatable screen such that the second plurality of ribs on the first screen section of the stationary screen bisects and partially obstructs the first plurality of slots in the rotatable screen as the first plurality of slots move past the first section of the stationary screen in response to rotation of the rotatable screen. The stationary screen also has a second screen section positioned between the cutter assembly and the rotatable screen that terminates at a fixed location adjacent the outlet end of the housing and intermediate the one side thereof and the opposite side thereof, such that the plurality of slots in the rotatable screen are not bisected or partially or otherwise obstructed by the second plurality of ribs of the second screen section of the stationary screen at the outlet end of the housing. Finally drive means for rotating the rotatable screen are provided for rotating the rotatable screen, such that in response to its rotation the rotatable screen cooperates with the stationary screen to transfer solids in the wastewater stream to the cutter assembly.

The cutter assembly includes a plurality of cutting stacks, at least one of which is positioned adjacent the one side of the housing, and at least another one of the cutting stacks being positioned adjacent the stationary screen. The cutter assembly can be removable from the housing, independently of the rotatable screen and the stationary screen.

In another embodiment, the stationary screen includes a vertical support member coupled to the second screen section of the stationary screen and to the bottom of the housing. The second screen section of the stationary screen can partially surround the cutter assembly, such that the cutter assembly is adapted to remove debris from the second screen section of the stationary screen. The cutter assembly can also be adapted to remove accumulated debris from the vertical support member of the stationary screen.

In a further embodiment, the rotatable screen further includes a plurality of spaced-apart scraper bars, adapted to rotate conjointly with the rotatable screen. Each scraper bar of the plurality of scraper bars is positioned within a corresponding one of the first plurality of slots in the rotatable screen.

In another embodiment, the first plurality of ribs on the rotatable screen are interleaved with the second plurality of ribs on the first screen section of the stationary screen. In this manner, the first plurality of ribs on the rotatable screen can cooperate with the second plurality of ribs on the first screen section of the stationary screen to form a composite fine screen at the inlet end of the housing, which composite fine screen includes interleaved ribs of the rotatable screen and the first screen section of the stationary screen.

The first plurality of slots of the rotatable screen can have a first width, and the interleaved ribs of the composite fine screen can form a second plurality of spaced-apart, generally horizontal slots. These second plurality of slots of the composite fine screen can have a second width that is less than the first width of the first plurality of slots of the rotatable screen. Similarly, the first plurality of ribs on the rotatable screen can form a coarse screen at the outlet end of the housing. In this manner, the second screen section of the stationary screen can be configured to screen solids comminuted by the cutter assembly. In an additional embodiment, the rotatable screen has a circumference with an interior within the rotatable screen that is bounded by the circumference thereof. Such an embodiment of the inventive comminutor can include a removable section of the rotatable screen that is adapted to permit access to the interior of the rotatable screen upon removal of the removable section from the removable screen. The removable section can constitute, for instance, about one fourth, about one third, or about one half of the circumference of the rotatable screen. The removable section can also have a height that is the substantially equivalent to the height of the rotatable screen. Additionally, the rotatable screen can include a pair of bifurcated pillars positioned in the interior of the rotatable screen on diametrically opposed sides thereof. Each bifurcated pillar of the pair of bifurcated pillars can include a plurality of removable, spaced-apart scraper bars adapted to rotate conjointly with the rotatable screen and the pair of bifurcated pillars. Each scraper bar of the plurality of scraper bars can be positioned within a corresponding one of the first plurality of slots in the rotating screen.

In yet another embodiment, the rotatable screen of the comminuting device of the present invention effectively functions as a fine screen proximal the inlet end of the housing and a coarse screen proximal the outlet end of the housing. Another aspect of the present invention involves a method involving the provision of a comminutor and a rotatable screen that operate to direct the waste into a cutter assembly. A stationary screen is simultaneously employed to block large particle waste from passing through the rotatable screen, using horizontal members attached to the stationary screen in combination with similar members on the rotatable screen. In this manner waste can be comminuted using the cutter assembly.

### BRIEF DESCRIPTION OF FIGURES

For a more complete understanding of the present disclosure, reference is made to the following figures, in which:

FIG. 1 is a front elevational view of a grinding and screening machine according to an embodiment of the present invention that employs a double drive;

FIG. 2 is a rear perspective view of the grinding and screening machine illustrated in FIG. 1, but with one drive removed;

FIG. 3 is a partial front perspective view of the grinding and screening machine illustrated in FIG. 1;

FIG. 4 is a detailed front perspective view similar to FIG. 3;

FIG. 5 is a partial front perspective view of the grinding and screening machine illustrated in FIG. 1, with a top portion cut away to show the interior structure thereof in more detail;

FIG. 6 is a top plan view of the grinding and screening machine illustrated in FIG. 1, as taken along the cutaway view of FIG. 5;

FIG. 7 is a vertical sectional view, taken along section line 7-7 of FIG. 6, of the grinding and screening machine illustrated in FIG. 1, but modified for a single drive;

FIG. 8 is a partial front perspective view similar to FIG. 5, but looking from a different direction;

FIG. 9 is an exploded perspective view of an embodiment of a rotary screen assembly employed by the grinding and screening machine illustrated in FIG. 1;

FIG. 10 is a perspective view of a stationary screen employed by the grinding and screening machine illustrated in FIG. 1;

FIG. 11 is a top perspective view and partial rear view of an alternate embodiment of a grinding and screening machine similar to the embodiment of FIG. 1, but with a modified rotary screen assembly, a top portion of the machine being cut away to show the interior structure thereof, including the modified rotary screen assembly; and

FIG. 12 is a top plan view of the alternate embodiment of the grinding and screening machine illustrated in FIG. 11.

### DETAILED DESCRIPTION OF EXEMPLARY EMBODIMENTS

Reference will now be made to several embodiments of the present invention, examples of which are illustrated in the accompanying figures. Wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

All terms defined herein should be afforded their broadest possible interpretation, including any implied meanings as dictated by a reading of the specification as well as any words that a person having skill in the art and/or a dictionary, treatise, or similar authority would assign thereto.

The terms, “for example”, “e.g.”, “optionally”, as used herein, are intended to be used to introduce non-limiting examples. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.” In addition, the terms “comprises” and “comprising” when used herein specify that certain features are present in that embodiment; however, this phrase should not be interpreted to preclude the presence or addition of additional steps, operations, features, components, and/or groups thereof.

With the foregoing prefatory comments in mind, the present invention relates to a grinding (comminuting) and screening machine, or system, positionable and used in wastewater channels. As further discussed below, the inventive grinding and screening machine employs a rotatable screen (i.e., a rotary/rotating drum screen) that feeds solids into a cutter assembly for more effective particle reduction of materials commonly found in wastewater streams such as rags, plastics, wood, tampons, sanitary napkins, wipes and more. An enhanced flow capacity is achieved by combining the rotatable screen with a stationary screen, as further discussed below.

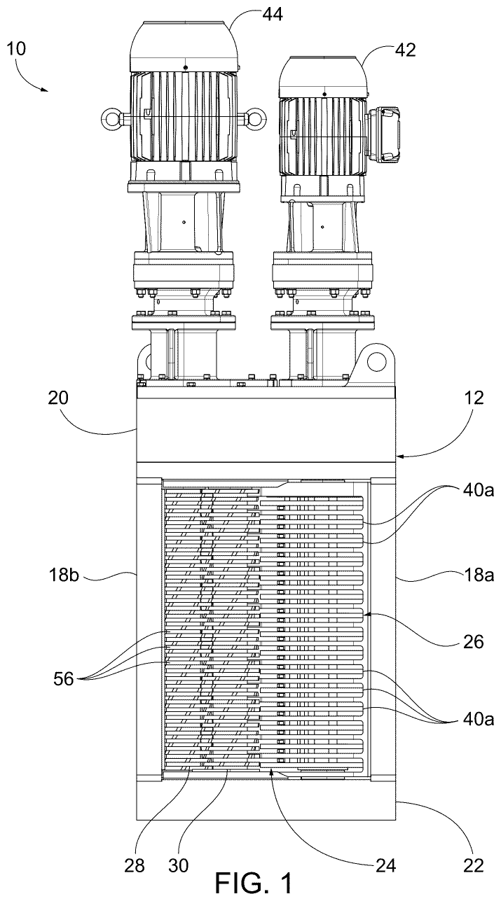

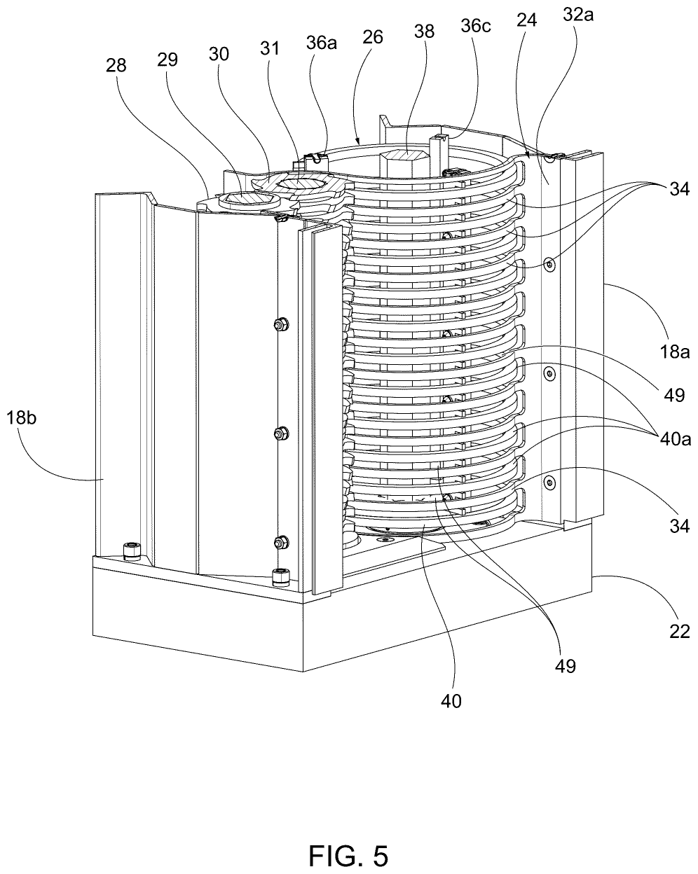

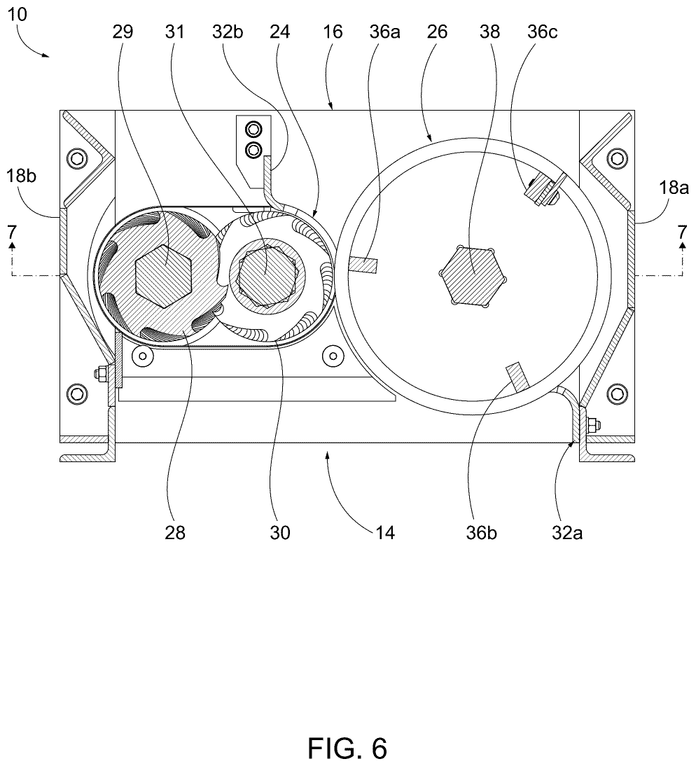

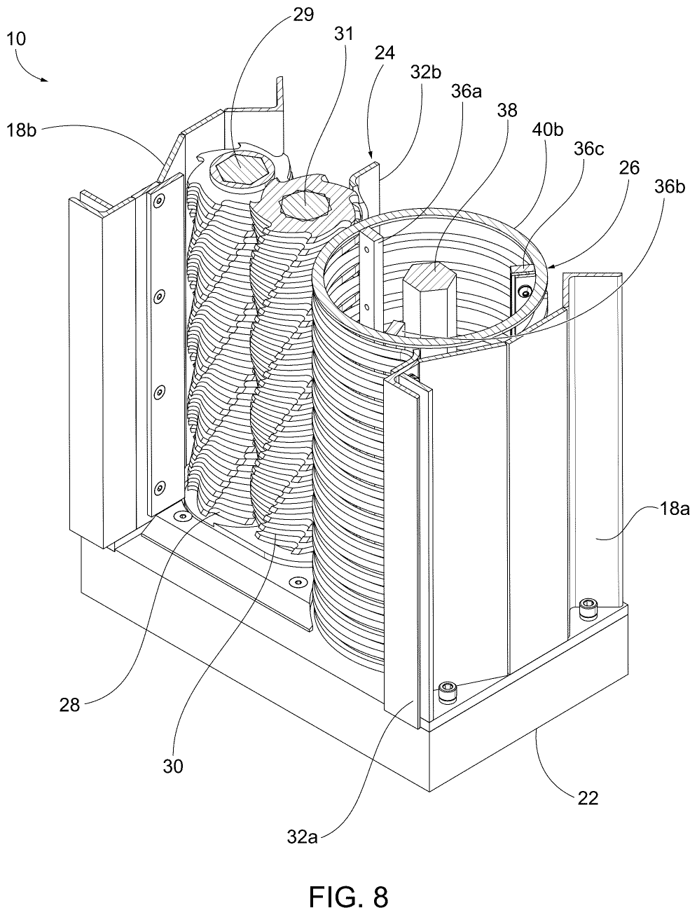

With reference now to FIGS. 1-8, the aforementioned grinding and screening machine 10 includes a housing 12 having an inlet end, or face, 14, for receiving wastewater flowing through a channel and for grinding solids therein, an outlet end, or face, 16, for discharging wastewater from the housing 12, opposed sides 18a, 18b, a top 20 and a bottom 22. The housing 12 contains a stationary screen 24, a rotary/rotating drum screen 26 and two intermeshing cutting stacks, or cutters, 28, 30 that constitute the rotatable cutter assembly, or grinder, which is configured to grind solids in the wastewater stream upon rotation of the cutter assembly. Cutters 28, 30 are mounted to the housing 12 and positioned between the inlet end 14 and outlet end 16. They are adjacent to one side 18b of the housing 12 and can be attached to same. Alternatively, cutters 28, 30 are coupled to bottom 22 of housing 12, or are suspended therefrom by shaft(s).

In an embodiment, upon removal of the top 20, the cutters 28, 30 can be removed from the housing 12 as a unit independently of the rest of the machine 10. In other words, the entire cutter assembly is replaceable and interchangeable with other similar cutter assemblies. In another embodiment, the entire machine 10 can be removed from the channel, with or without drives 42, 44 described hereinbelow.

After entering the inlet face or end 14 of the machine 10, an in-flow of liquid and solid particles from an effluent stream flows directly into cutters 28, 30 or is redirected by rotatable screen 26 into the cutters 28, 30. In either case, these solid material particles impact upon the rotating, cutting and grinding teeth 56 of cutters 28, 30, and are shredded into small or minute particles. In the embodiment of FIG. 1, the cutter 28 has a central shaft 29, and the cutter 30 has a central shaft 31. The cutters 28, 30 are rotated by shafts 29, 31, respectively, which can be driven by a motor or any number of mechanisms. Typically, the shafts would provide rotations opposite one another, in order to rotate cutters 28, 30 in opposite directions and thereby enhance comminuting functionality.

The cutter stacks 28, 30 can be constructed in accordance with any number of embodiments, such as those disclosed in U.S. Pat. No. 5,406,865, which is incorporated herein by reference and made a part of the present application for all purposes. Such arrangements can involve at least a pair of rotating shafts with their axes of rotation parallel to one another, with sets or stacks of individual cutter disks and spacers in an alternate spaced-apart relationship fixedly mounted on each shaft and mutually intermeshing.

The stationary screen 24 is mounted to the housing 12 in a fixed orientation, relative to the cutters 28, 30 of the rotary cutter assembly and the rotatable screen 26. The stationary screen 24 has a first screen section 52 extending from bottom 22 of housing 12. First screen section 52 extends toward the one side 18b of the housing 12 in close proximity to the rotatable screen 26. As will be explained in greater detail below, first screen section 52 includes a plurality of spaced-apart horizontal ribs 34 that are interleaved with horizontal ribs 40 of rotatable screen 26.

The stationary screen 24 also has a second screen section 54 positioned between the cutter 30 and the rotatable screen 26. Stationary screen 24 is mounted to bottom 22 of housing 12 and terminates at a fixed location adjacent the outlet end 16 of the housing 12, intermediate the one side 18b thereof and the opposite side 18a thereof and between the first screen section 52 and the opposite side 18a. Stationary screen 24 also partially surrounds the cutter assembly (i.e., cutters 28 and/or 30) and, in addition to the plurality of horizontal ribs 34, it also includes a vertical support member 32b attached to bottom 22 of the housing 12. In embodiments in which stationary screen 24 partially surrounds the cutter assembly, teeth 56 of cutter 30 rotate close enough to the second screen section 54 to remove, via a scraping action, debris that may have accumulated thereon.

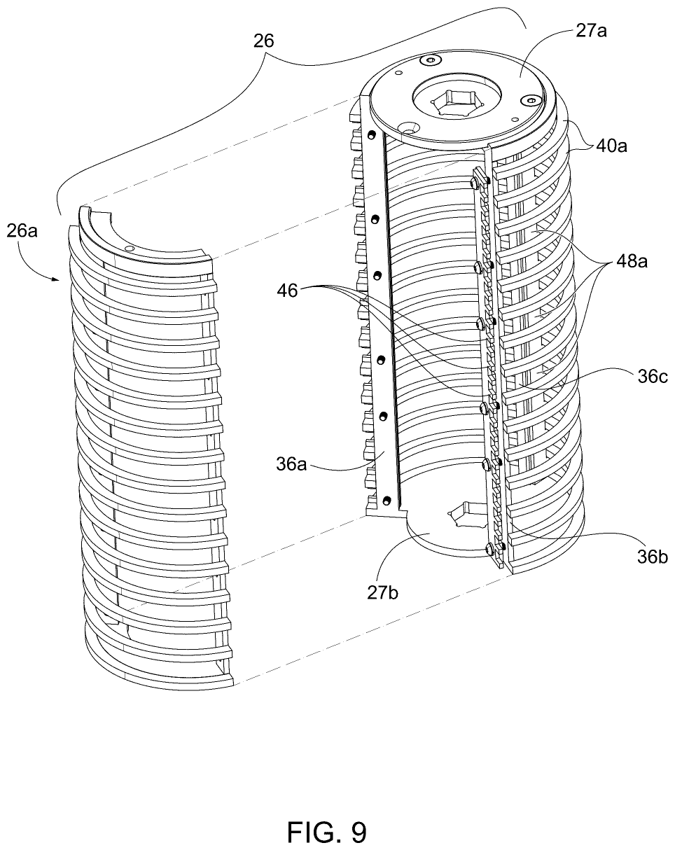

The rotating drum screen 26 is mounted to the housing 12, between the inlet and outlet ends 14, 16 and adjacent the opposite side 18a of the housing 12. It includes top and bottom plates 27a, 27b (See FIG. 9), three equally spaced vertical support members 36a, 36b, 36c that extend between the top and bottom plates 27a, 27b, a vertical support member 32a coupled to side 18a, a central shaft 38, and the aforementioned ribs 40. In an embodiment, rotatable screen 26 is coupled to side 18a via intermediate vertical support member 32a. In other embodiments, the rotating drum screen 26 may include different numbers of vertical support members or no such vertical support members. Plates 27a, 27b can be used to actuate rotation of the rotatable screen 26, driven by one or more drive shafts.

The rotatable screen 26 cooperates with the stationary screen 24 to transfer solids captured thereon to the cutter assembly (i.e., the cutters 28, 30) upon rotation of the rotatable screen 26. The spaced-apart ribs 34, 40 define a plurality of slots 49 that are sized and shaped so as to permit wastewater to flow through the rotatable screen 26.

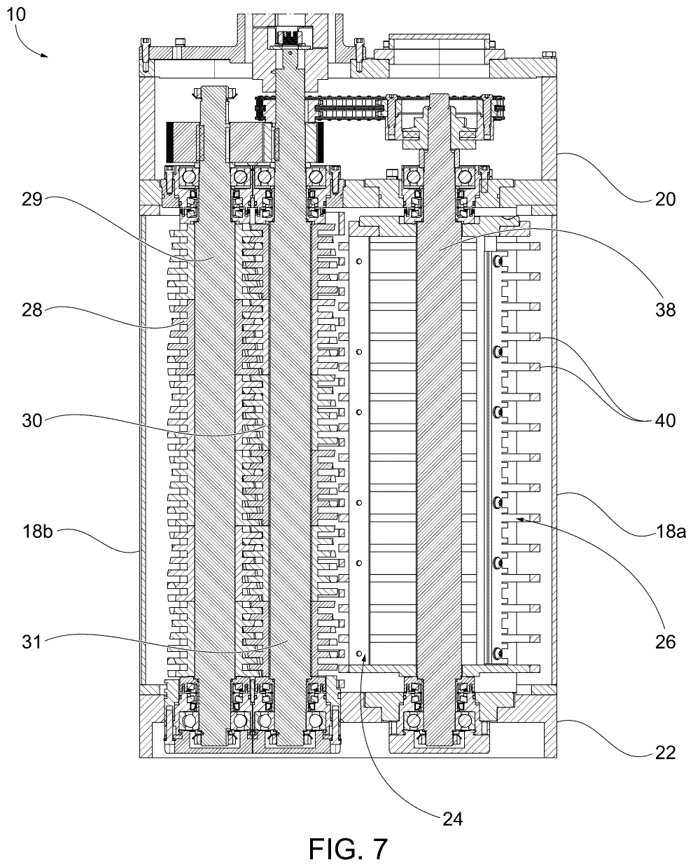

The machine 10 further includes drivers 42, 44 (as shown in FIG. 1). The driver 42 operably connects to the central shaft 38 of the rotating drum screen 26 and drives the rotational movement of the rotating drum screen 26. The driver 44 operably connects to the central shaft 29 of the cutter 28 and drives the rotational movement of the cutter 28 and the cutter 30 (i.e., via rotation of the cutter 28, which is interleaved with the cutter 30). In other embodiments, as depicted in FIG. 7, the machine 10 includes only one driver (not shown), which drives all of the shafts 29, 31 and 38 via a linkage or any other suitable mechanism.

As indicated above, the driver 42 constitutes drive means for rotating the rotatable screen 26 such that upon its rotation, the rotatable screen 26 cooperates with the stationary screen 24 to transfer solids in the wastewater stream to the cutter assembly (i.e., the cutters 28, 30). More particularly, the rotatable screen 26 directs the wastewater flow, so as to cause and divert or direct the solids to flow toward or into the cutters 28, 30. The ribs 40 of the rotatable screen 26 have fore portions 40a facing the inlet face (i.e., end) 14 of the housing 12 and aft portions 40b facing the outlet face (i.e., end) 16 of the housing 12. Of course, each fore portion 40a cooperates with its contiguous aft portion 40b to form a corresponding one of the ribs 40 of the rotatable screen 26.

Rotatable screen 26 has a plurality of slots 48 of uniform width that are defined by the gaps between adjacent horizontal ribs 40. These slots 48 are visible on outlet face or end 16, as defined by portions 40b of horizontal ribs 40. For this reason, rotating screen 26 acts as a coarse screen on outlet face or end 16 for efflux purposes. On the other hand, while portions 40a of the horizontal ribs on inlet face or end 14 have the same separation distance as portions 40b, corresponding slots 48 on the inlet face 14 are sub-divided or bisected by horizontal ribs 34 of stationary screen 24 to form a second plurality of slots 49, each of which is framed by one of the horizontal ribs 34 and one of the horizontal ribs 40. In this manner, slots 48 on the front end are effectively reduced by the width of horizontal ribs 34, and the remainder of the width is divided between a pair of slots 49 for each slot 48 on inlet end 14 of housing 12. This smaller effective slot width means that slots 49 permit rotating screen 26 and the first screen section 52 of the stationary screen 24 to effectively act as a composite fine screen on inlet end 14, limiting influx of larger waste particles into the interior of rotatable screen 26. This bisecting function divides slots 48 to form slots 49; however, it should be understood that non-symmetrical slots 49 could also be formed (i.e., the slots of a given pair of slots 49 could have different widths). Proximal the inlet face or end 14 of housing 12, horizontal ribs 40 of rotatable screen 26 are therefore interleaved with horizontal rib members 34 of stationary screen 24 and vice-versa. Of course, as rotatable screen 26 is rotated, portions 40a and 40b also rotate, which means that they switch not only positions but also functionality. By way of example, when rotatable screen 26 rotates 180 degrees, portions 40b would help define slots 49 on the inlet end 14 of the housing 12, while portions 40a would help define slots 48 on the outlet end 16 of the housing 12.

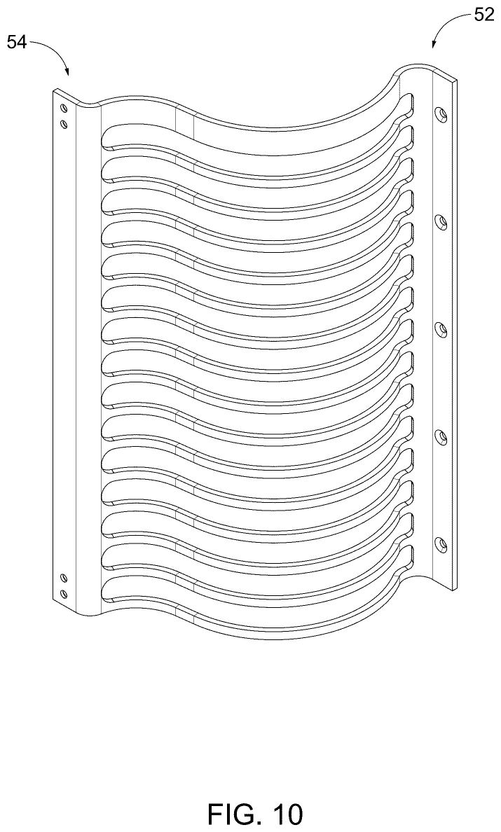

Similarly, a third plurality of slots 50 is defined in the stationary screen (see FIG. 10) proximal the second screen section 54 by sections of horizontal ribs 34 that do not interleave with horizontal ribs 40a. These slots 50 are relatively large, permitting the wastewater to flow through, and in some embodiments, permitting comminuted waste processed by cutters 28, 30 to exit via outlet face or end 16 of housing 12.

As explained hereinabove, the horizontal ribs 40a of the rotating drum screen 26 interleave with the horizontal ribs 34 of the stationary screen 24 to effectively create a fine screen at the inlet face or end 14 of the housing 12 as a result of slots 48 being partially obstructed by horizontal ribs 34. In contrast, slots 48 on the outlet face or end 16 are defined solely by the spacing between horizontal ribs 40b and are thus wider than the slots 49, thereby creating a coarser screen at the outlet face or end 16 of the housing 12. This construction minimizes or eliminates a common problem in the prior art rotating screens, namely, the accumulation of solids trapped within the rotary screen over time (which results in a significant degrading of the liquid capacity of the unit and premature failure of the grinding system). The stationary and rotating drum screens 24, 26, respectively, are located close to/proximate the cutters 28, 30 to enhance transfer of solids to the cutters 28, 30 without the solids bypassing the cutters 28, 30.

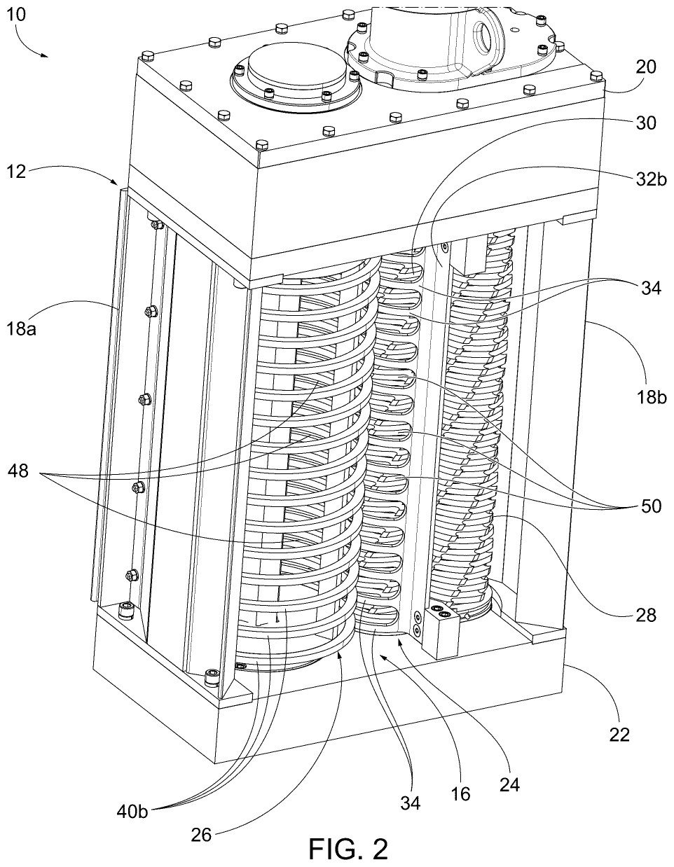

As shown in FIGS. 2, 5, 6 and 8, the stationary screen 24 may be configured to wrap partially around one of the cutters (i.e., the cutter 30) in order to help clear the stationary screen's vertical support member 32b of debris, in addition to doing the same for second screen section 54.

In other embodiments of the invention (not illustrated), the machine 10 may include and employ two rotating drum screens 26, one located on either side of the cutters 28, 30 (i.e., grinder unit), whereby both rotating drum screens 26 are configured to feed solids towards the cutters 28, 30. Each of these rotating drum screens 26 may be driven by a separate drive or be driven via a drive train with the cutters 28, 30.

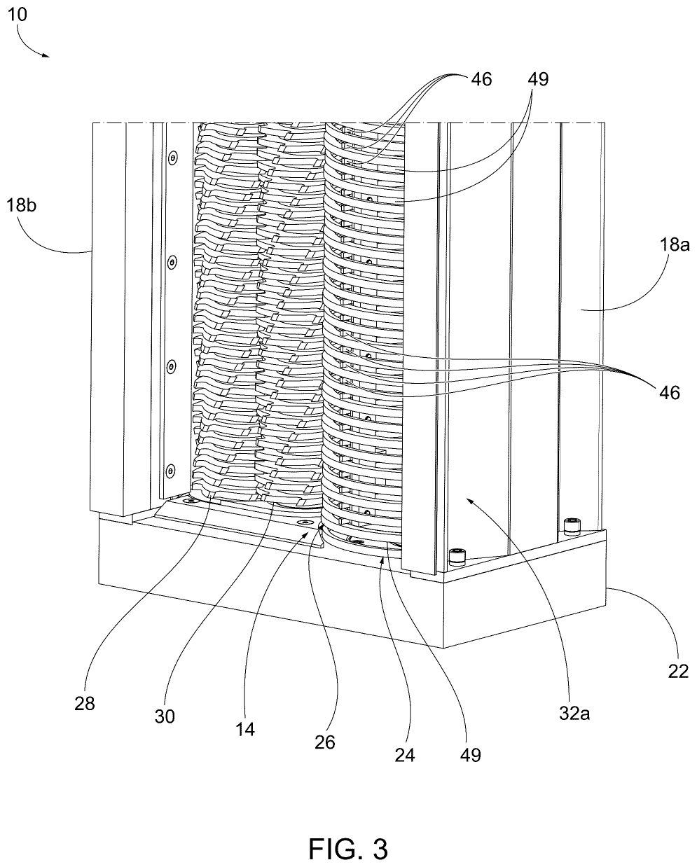

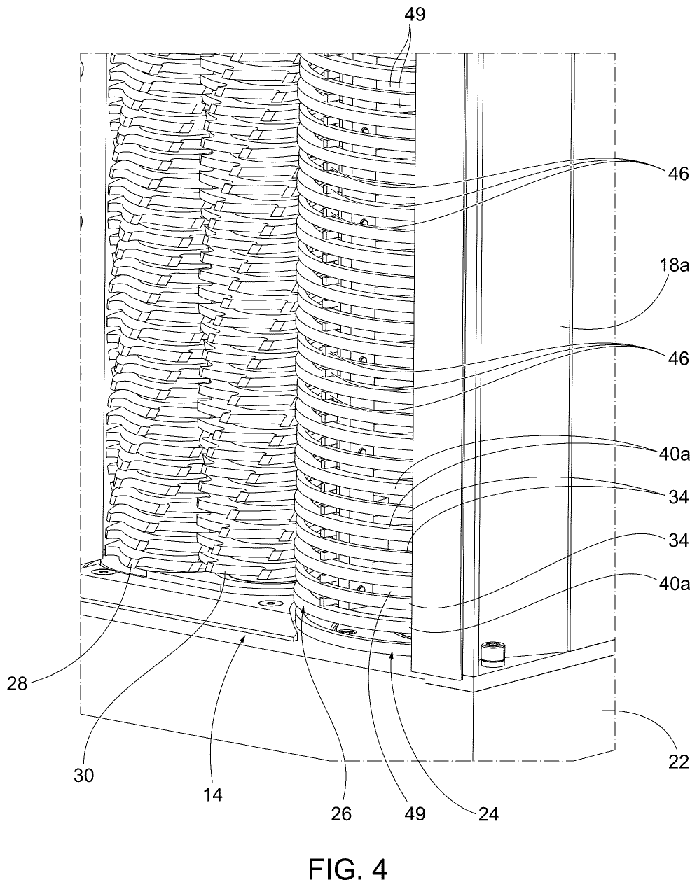

The machine 10 further includes a scraper bar or scraper bars 46 within the rotating drum screen 26 to assist in removing solids (i.e., debris) from the stationary screen 24 (see FIGS. 3 and 4). In some embodiments, the scraper bars 46 may intermesh with the cutters 28, 30. The scraper bars 46 would be interleaved with horizontal members, 34, 40 and, when rotated conjointly with rotatable screen 26, function to scrape off debris accumulated on the second section 54 of the stationary screen 24.

The operation of the machine 10 in a wastewater channel will now be described. As the solids flow into the inlet face or end 14 and are captured on the rotating drum screen 26, they are carried with the rotating drum screen 26 towards the cutters 28, 30 where they are captured by the cutter 30 closest to the rotating drum screen 26 and drawn into the intermeshing cutters 28, 30 and reduced to a small size.

As described above, the horizontal ribs 40 of the rotating drum screen 26 interleave with the horizontal ribs 34 of the stationary screen 24 to create a composite fine screen at the inlet face or end 14 and a coarser screen at the outlet face or end 16. In other words, since the stationary screen 24 is in close proximity to rotatable screen 26, the first screen section 52 of the stationary screen 24 partially obstructs the plurality of slots 48 in the rotatable screen 26 as the ribs 40 rotate past the first screen section 52 of the stationary screen 24 upon rotation of the rotatable screen 26. Some very small solids may go directly through the rotating drum screen 26 through slots 49, and as opposed to prior art machines, these solids easily exit the back side of the machine 10 (i.e., the outlet face or end 16) through slots 48. In other words, these very small solids can pass between the horizontal ribs 34, 40 and exit the machine's outlet end 16 without getting trapped within the rotating drum screen 26. This is because the slots 48 in the rear of the rotating drum screen 26 (i.e., proximate the outlet end 16), are much larger (i.e., providing a coarser screen) than those in the front of the machine 10 (i.e., the inlet end 14, where the overall screen is finer), because the slots 48 in the rotatable screen 26 are not partially or otherwise obstructed by the second screen section 54 of the stationary screen 24 at the outlet end 16 of the housing 12.

FIG. 9 illustrates an alternate embodiment of the machine's rotating drum screen 26, which includes a removable section (i.e., screen wedge) 26a. The removable section 26a is provided with connection means (not shown) that enables it to be removably connected to vertical support members 36a, 36b of the rotating drum screen 26. Alternatively, the removable section 26a can attach to rotatable screen 24 via horizontal ribs 40. In various embodiments, the connection means of the removable screen section 26a includes flanges and/or bolts that are configured to removably connect to the vertical support members 36a, 36b. In other embodiments, the connection means are configured to connect the removable section 26a to the top and bottom plates 27a, 27b of the rotating drum screen 26. The removable section 26a facilitates performing maintenance on the rotating drum screen 26 without having to dismantle the whole machine 10. While the removable screen wedge section 26a is illustrated as constituting about one third (⅓) of the circumference of the rotating drum screen 26 and the same height as that of the rotating drum screen 26, in other embodiments, the removable screen wedge section 26a has other sizes and/or configurations, including, but not limited to, about half (½) or about one quarter (¼) of the circumference of the rotating drum screen 26, and/or a height that is less than that of the rotating drum screen 26.

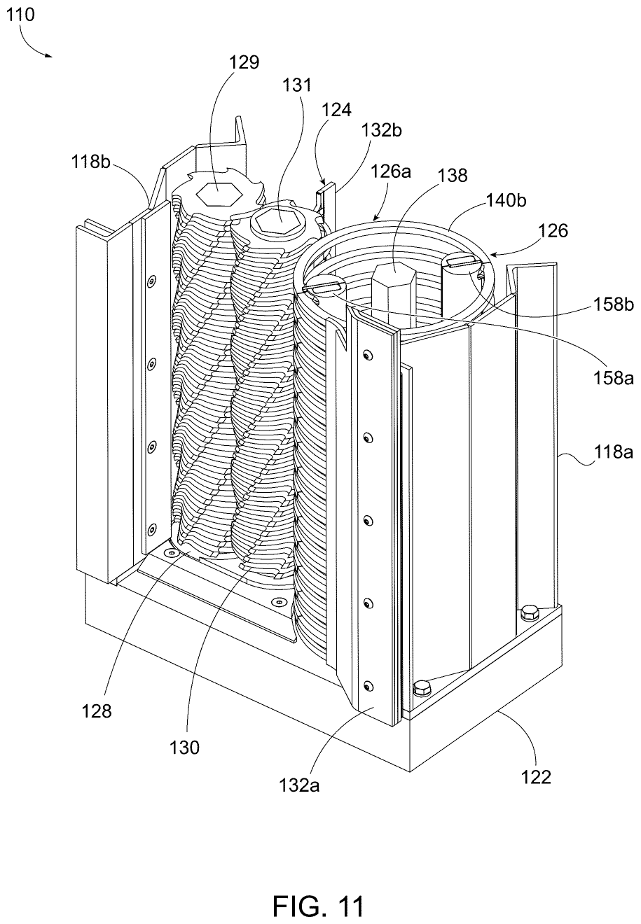

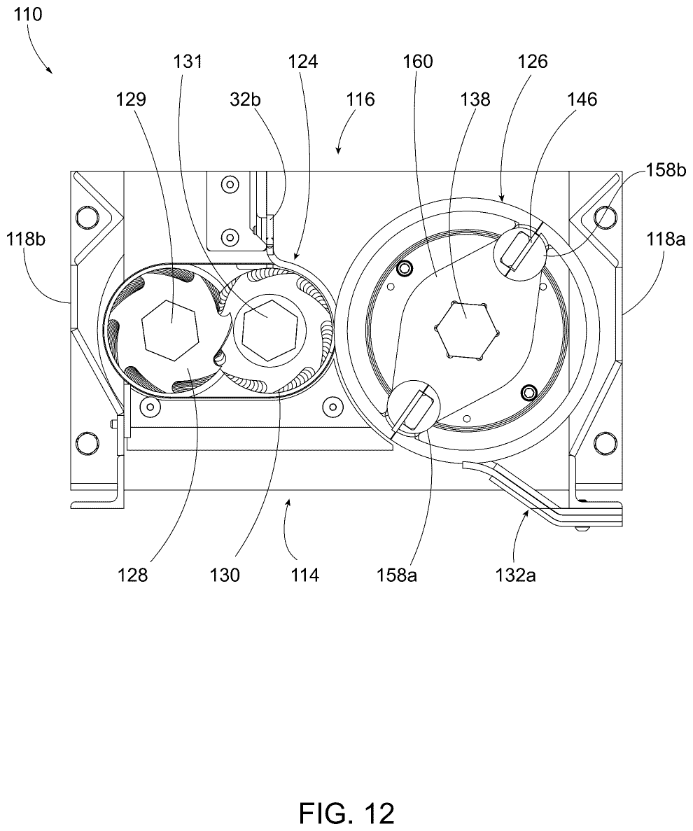

An alternate embodiment of the present invention is shown in FIGS. 11 and 12. Like parts in FIGS. 11 and 12 are labeled with the same reference numbers used in FIGS. 1-10 increased by one hundred (i.e., 100) and work mostly identically with the exceptions that follow. Initially, it should be noted that the removable section 126a of the rotatable screen 126 is half (½) the circumference of the rotatable screen 126, which therefore essentially consists of a pair of twin sections encircling an interior of the rotatable screen 126 that can be accessed by removing either of the sections. The drive shaft 138 for rotating the screen 126 carries a yoke 160 which supports a pair of bifurcated pillars 158a, 158b arranged in the interior of the rotatable screen 126 at locations that are diametrically opposed to one another. The bifurcated pillars 158a, 158b have a circular cross-sectional shape and each of the pillars is formed by a pair of substantially identical halves that are removably attached to one another by any suitable means. Each of the bifurcated pillars 158a, 158b carries a plurality of removable, spaced-apart scraper bars 146. The yoke 160 and hence the bifurcated pillars 158a, 158b and their associated scraper bars 146 rotate conjointly with the rotatable screen 126 in response to rotation of the draft shaft 138. This construction allows damaged or used scraper bars 146 to be accessed and replaced. The bifurcated pillars 158a, 158b are also accessible for replacement and/or repair upon removal of the screen section 126a, which, as a consequence of its removal, is also adapted for replacement and/or repair.

The present invention facilitates an enhanced flow capacity based on the combination of the rotating drum screen with the grinder/cutters. The present invention also facilitates improved screen operation and increased screening efficiency based on the combination of the stationary screen and rotating drum screen. The present invention thereby provides an improvement over prior art wastewater channel grinding systems.

It will be understood that the embodiments described herein are merely exemplary and that a person skilled in the art may make many variations and modifications without departing from the spirit and scope of the invention. All such variations and modifications are intended to be included within the scope of the present invention as it is explicitly and inherently described hereinabove and as illustrated in the accompanying drawings.

1. A comminuting apparatus adapted for screening a wastewater stream flowing through a channel and for grinding solids in the wastewater stream, said apparatus comprising:
a housing positionable in the channel, said housing having an inlet end for receiving wastewater flowing through the channel and an outlet end for discharging wastewater from said housing;
a rotatable cutter assembly mounted to said housing between said inlet and outlet ends and adjacent one side of said housing, said cutter assembly being configured to grind solids in the wastewater stream upon rotation of said cutter assembly;
a rotatable screen mounted to said housing between said inlet and outlet ends and adjacent an opposite side of said housing, a portion of said rotatable screen being in close proximity to said cutter assembly, said rotatable screen having a first plurality of spaced-apart, generally horizontal ribs configured to transfer solids captured thereon to said cutter assembly in response to rotation of said rotatable screen, said first plurality of ribs defining a first plurality of generally horizontal slots sized and shaped so as to permit wastewater to flow through said rotatable screen;
a stationary screen mounted to said housing in a fixed orientation relative to said cutter assembly and to said rotatable screen, said stationary screen having a second plurality of spaced-apart, generally horizontal ribs, a first screen section attached to said housing at said opposite side thereof and extending toward said one side thereof in close proximity to said rotatable screen such that said second plurality of ribs on said first screen section of said stationary screen bisect and partially obstruct said first plurality of slots in said rotatable screen as said first plurality of slots move past said first screen section of said stationary screen in response to rotation of said rotatable screen, and a second screen section positioned between said cutter assembly and said rotatable screen and terminated at a fixed location adjacent said outlet end of said housing intermediate said one side thereof and said opposite side thereof such that said first plurality of slots in said rotatable screen are not bisected or partially or otherwise obstructed by said second plurality of ribs on said second screen section of said stationary screen at said outlet end of said housing; and
drive means for rotating said rotatable screen such that in response to its rotation said rotatable screen cooperates with said stationary screen to transfer solids in the wastewater stream to said cutter assembly.

2. The comminuting apparatus of claim 1, wherein said rotatable cutter assembly includes a plurality of cutting stacks, at least one of said cutting stacks being positioned adjacent said one side of said housing and at least another one of said cutting stacks being positioned adjacent said stationary screen.

3. The comminuting apparatus of claim 2, wherein said cutter assembly is removable from said housing independently of said rotatable screen and said stationary screen.

4. The comminuting apparatus of claim 1, wherein said rotatable screen includes a plurality of spaced-apart scraper bars adapted to rotate conjointly with said rotatable screen, each scraper bar of said plurality of scraper bars being positioned within a corresponding one of said first plurality of slots in said rotatable screen.

5. The comminuting apparatus of claim 4, wherein said stationary screen includes a vertical support member coupled to said second screen section of said stationary screen and to a bottom of said housing.

6. The comminuting apparatus of claim 5, wherein said second screen section of said stationary screen partially surrounds said cutter assembly, such that said cutter assembly is adapted to remove accumulated debris from said second screen section of said stationary screen.

7. The comminuting apparatus of claim 6, wherein said cutter assembly is also adapted to remove accumulated debris from said vertical support member of said stationary screen.

8. The comminuting apparatus of claim 1, wherein said first plurality of ribs on said rotatable screen are interleaved with said second plurality of ribs on said first screen section of said stationary screen.

9. The comminuting apparatus of claim 8, wherein said first plurality of ribs on said rotatable screen cooperate with said second plurality of ribs on said first screen section of said stationary screen to form a composite fine screen at said inlet end of said housing, said composite fine screen including interleaved ribs of said rotatable screen and said first screen section of said stationary screen.

10. The comminuting apparatus of claim 9, wherein said first plurality of slots of said rotatable screen have a first width.

11. The comminuting apparatus of claim 10, wherein said interleaved ribs of said composite fine screen form a second plurality of spaced-apart, generally horizontal slots.

12. The comminuting apparatus of claim 11, wherein said second plurality of slots of said composite fine screen have a second width which is less than said first width of said first plurality of slots of said rotatable screen.

13. The comminuting apparatus of claim 12, wherein said first plurality of ribs on said rotatable screen form a coarse screen at said outlet end of said housing.

14. The comminuting apparatus of claim 13, wherein said second screen section of said stationary screen is configured to screen solids comminuted by said cutter assembly.

15. The comminuting apparatus of claim 1, wherein said rotatable screen has a circumference and an interior within said rotatable screen and bounded by said circumference thereof.

16. The comminuting apparatus of claim 15, wherein said rotatable screen has a removable section adapted to permit access to said interior of said rotatable screen upon removal of said removable section from said rotatable screen.

17. The comminuting apparatus of claim 16, wherein said removable section constitutes about one third of said circumference of said rotatable screen.

18. The comminuting apparatus of claim 16, wherein said removable section constitutes about one fourth of said circumference of said rotatable screen.

19. The comminuting apparatus of claim 16, wherein said removable section constitutes about one half of said circumference of said rotatable screen, said removable section and said rotatable screen having substantially equivalent heights.

20. The comminuting device of claim 19, wherein said rotatable screen includes a pair of bifurcated pillars positioned in said interior of said rotatable screen on diametrically opposed sides thereof, each bifurcated pillar of said pair of bifurcated pillars including a plurality of removable, spaced-apart scraper bars adapted to rotate conjointly with said rotatable screen and said pair of bifurcated pillars, each scraper bar of said plurality of scraper bars being positioned within a corresponding one of said first plurality of slots in said rotatable screen.
